(19) United States
(12) Patent Application Publication
(10) Pub. No.: US 2009/0153429 A1
(43) Pub. Date: Jun. 18, 2009

(54) Multi-band antenna assembly

(75) Inventors: Chia-Hung Su, Taipei (TW); Chian-Chou Chiang, Taipei (TW); Chia-Ching Lin, Taipei (TW); Ting-Chih Tseng, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 12/314,576

(22) Filed: Dec. 12, 2008

(30) Foreign Application Priority Data
Dec. 12, 2007 (TW) 096147356

(51) Int. Cl. H01Q 19/02

(52) U.S. Cl. 343/818; 343/833

(57) ABSTRACT

The invention provides a multi-band antenna assembly comprising a connection conductor, a first resonant element, a second resonant element, and a parasitic resonant element. The first resonant element and the second resonant element are electrically connected with the connection conductor respectively. The parasitic resonant element and a grounding part of the connection conductor are grounded. The parasitic resonant element is disposed substantially parallel to the first resonant element, and therein a length of the parasitic resonant element is 15.2 mm˜25.2 mm. The multi-band antenna assembly can provide a working band containing GSM850/GSM900/DCS/PSC/UMTS, even 2.4 GHz or GPS.

### BACKGROUND OF THE INVENTION

1. Field of the Invention

The present invention relates to a multi-band antenna assembly, and more particularly, to a multi-band antenna assembly comprising a parasitic resonant element.

2. Description of the Prior Art

With a lot of wireless communication products produced, the early wireless communication bands are not enough for usage. Therefore, more and more wireless communication apparatuses which operate with wireless communication bands other than the old bands are published on the market. Basically, different bands need different antennas. Although bands with close frequencies can share the same antenna, the communication quality will decrease. Moreover, when the difference of frequency between two bands is too large, it is hard to use only one antenna to cover all the bands.

However, there are many wireless communication apparatuses with different bands on the market. For the manufacturer, designing individual antenna for different bands will raise production, research, development and inventory cost. For the user, changing the communication provider means the user has to change the communication apparatus which is inconvenient. Broadening the working band of communication apparatuses by increasing the number of antennas will raise the volume of antennas and it is not good for marketing.

Therefore an aspect of the invention is to provide a multi-band antenna assembly comprising a parasitic resonant element and the multi-band antenna assembly with less resonant elements can contain all needed frequency bands to solve the aforementioned problems.

### SUMMARY OF THE INVENTION

An aspect of the present invention is to provide a multi-band antenna assembly comprising a parasitic resonant element.

A multi-band antenna assembly of the invention comprises a connection conductor, a first resonant element, a second resonant element, and a parasitic resonant element. The connection conductor comprises a feeding part and a grounding part. The first resonant element comprises a first conductor and a second conductor connected with the first conductor. The first conductor is electrically connected with the connection conductor and the second resonant element is electrically connected with the connection conductor. The parasitic resonant element comprises a third conductor and a fourth conductor connected with the third conductor wherein the fourth conductor is disposed substantially parallel to the first conductor. The length of the parasitic resonant element is 15.2 mm˜25.2mm according to simulating information about return loss.

In one embodiment, the length of the parasitic resonant element is 19.2 mm. The first working band of the multi-band antenna assembly contains 840-980 MHz and the second working band of the multi-band antenna assembly contains 1700-2560 MHz.

In another embodiment, the length of the parasitic resonant element is 23.2 mm. The first working band of the multi-band antenna assembly contains 850-950 MHz and the second working band of the multi-band antenna assembly contains 1560-2190 MHz.

Additionally, the second conductor of the first resonant element comprises a gap, to increase the electric length of the second conductor to lower the frequency. The second resonant element comprises a gap, also, to increase the electric length of the second resonant element to lower the frequency.

Therefore, the multi-band antenna assembly with single parasitic resonant element can provide a working bank containing GSM850/GSM900/DCS/PCS/UMTS, even 2.4 GHz or GPS. This can prevent the large volume of antennas resulted from using a plurality of antennas to produce the needed working band.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates inner part of a cellular phone according to the first embodiment of the present invention.

FIG. 2A illustrates a multi-band antenna assembly.

FIG. 2B illustrates another view of a multi-band antenna assembly.

FIG. 3 illustrates a return loss diagram of the first embodiment.

FIG. 4 illustrates a multi-band antenna assembly according to the second embodiment.

FIG. 5 illustrates a return loss diagram of the second embodiment.

### DETAILED DESCRIPTION OF THE INVENTION

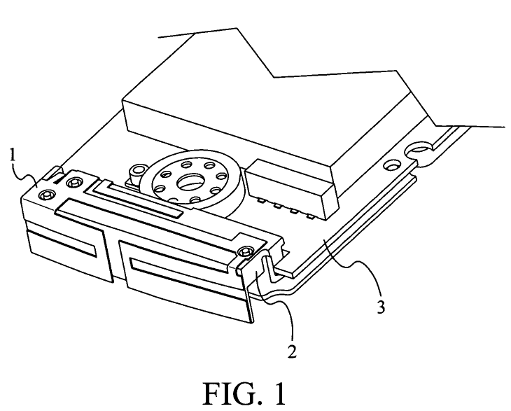

Please refer to FIG. 1. FIG. 1 illustrates inner part of a cellular phone according to the first embodiment of the present invention. As shown in FIG. 1, the multi-band antenna assembly 1 is supported by an antenna holder 2 and electrically connected with circuit board 3, to be collocated with a communication module to provide the wireless communication function for a cell phone.

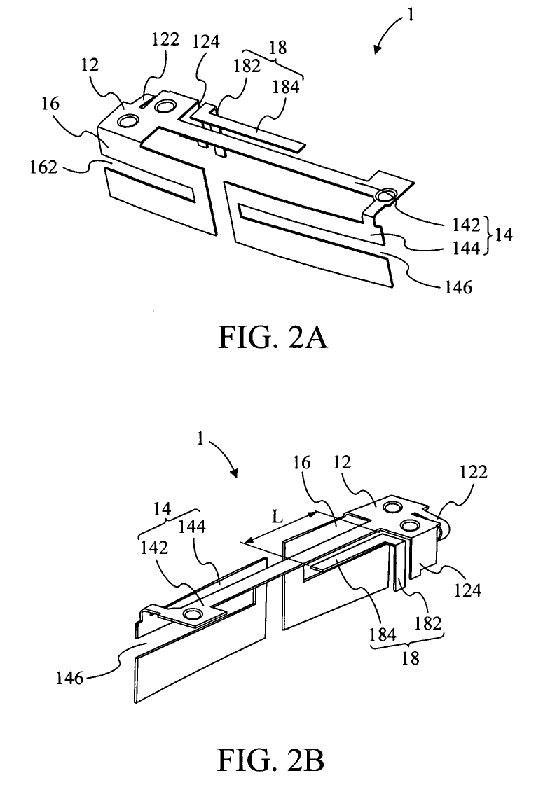

Please refer to FIG. 2A and 2B. FIG. 2A illustrates a multi-band antenna I assembly and FIG. 2B illustrates another view of the multi-band antenna assembly 1. The multi-band antenna assembly 1 comprises a connection conductor 12, a first resonant element 14, a second resonant element 16, and a parasitic resonant element 18. The connection conductor 12 comprises a feeding part 122 and a grounding part 124. The feeding part 122 is electrically connected with the circuit board 3 and the grounding part 124 is electrically connected with the circuit board 3.

The first resonant element 14 comprises a first conductor 142 and a second conductor 144 connected with the first conductor 142. The first conductor 142 is electrically connected with the connection conductor 12. The second conductor 144 is substantially perpendicular to the first conductor 142. The second resonant element 16 is electrically connected with the connection conductor 12 and substantially perpendicular to the connection conductor 12. The second conductor 144 of the first resonant element 14 comprises a gap 146, to increase the electric length of the first resonant element 14. The second resonant element 16 comprises a gap 162, to increase the electric length of the second resonant element 16.

The parasitic resonant element 18 comprises a third conductor 182 and a fourth conductor 184 connected with the third conductor 182. The third conductor 182 and the ground line of the circuit board 3 are grounded. The fourth conductor 184 is disposed substantially parallel to the first conductor 142 of the first resonant element 14 and the interval is approximately 1.1 mm. The length of the parasitic resonant element 18 is 23.2 mm. The length of the fourth conductor 184 is 15.3 mm represented as L in FIG. 2B.

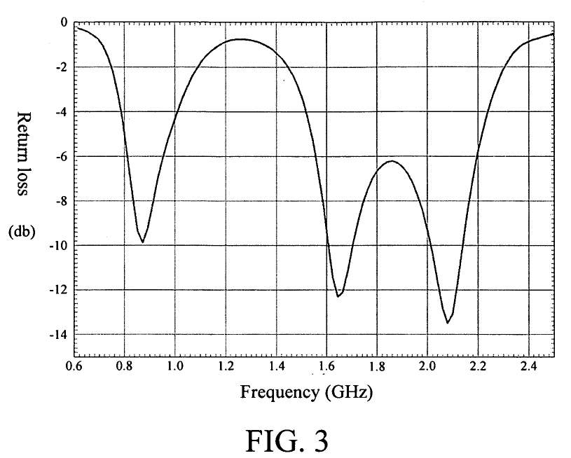

According to the first embodiment, the first working band of multi-band antenna assembly 1 contains 850-950 MHz and the second working band of multi-band antenna assembly 1 contains 1560-2190 MHz as shown in FIG. 3

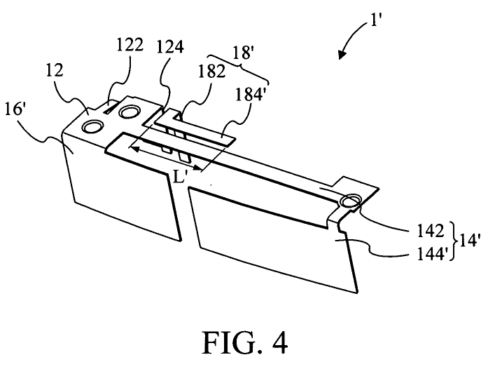

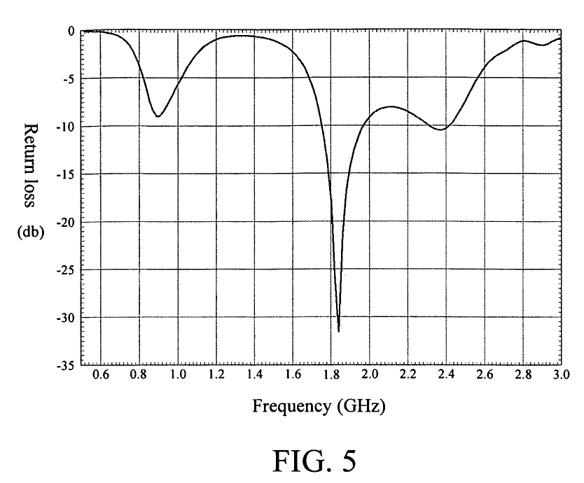

Please refer to FIG. 4. FIG. 4 illustrates the multi-band antenna assembly 1′ according to the second embodiment. The difference between the multi-band antenna assembly 1′ and the multi-band antenna assembly 1 in the first embodiment is the second conductor 144′ of the first resonant element 14′ of the multi-band antenna assembly 1′ and the second resonant element 16′ without a gap and the length of the parasitic resonant element 18′ of the multi-band antenna assembly 1′ is shorter. According to the second embodiment, the length of the parasitic resonant element 18′ of the multi-band antenna assembly 1′ is 19.2 mm. The length of the fourth conductor 184′ is 11.3 mm represented as L′ in FIG. 4. The first working band of multi-band antenna assembly 1′ contains 840-980 MHz and the second working band of multi-band antenna assembly 1′ contains 1700-2560 MHz as shown in FIG. 5.

Additionally, the third conductor of the parasitic resonant element of the multi-band antenna assembly of the invention is electrically connected with the grounding part of the connection conductor and then electrically connected with the ground line of the circuit board 3. Thereby, the multi-band antenna assembly of the invention is integrated and composes of metal or metalized materials. Additionally, the geometric characters of gap 146, 162 and the length of parasitic resonant element 18, 18′ are designed according to the request but not limited to the invention. Additionally, −6 db is the stander of return loss of the mentioned working band.

In summary, the multi-band antenna assembly of the invention with single parasitic resonant element can provide a working band containing GSM850/GSM900/DCS/PCS/UMTS, even 2.4 GHz or GPS. The working bank is not confined to use a plurality of antennas. Therefore, the multi-band antenna is applied to cell phones and wireless network, for example, Bluetooth, and Wi-Fi.

Although the present invention has been illustrated and described with reference to the preferred embodiment thereof, it should be understood that it is in no way limited to the details of such embodiment but is capable of numerous modifications within the scope of the appended claims.

What is claimed is:

1. A multi-band antenna assembly comprising:
a connection conductor comprising a feeding part and a grounding part;
a first resonant element comprising a first conductor and a second conductor connected with the first conductor, wherein the first conductor is electrically connected with the connection conductor;
a second resonant element connected with the connection conductor electrically; and
a parasitic resonant element comprising a third conductor and a fourth conductor connected with the third conductor wherein the fourth conductor is disposed substantially parallel to the first conductor and the length of the parasitic resonant element is 15.2 mm˜25.2 mm.

2. The multi-band antenna assembly of claim 1, wherein the second conductor is disposed substantially perpendicular to the first conductor.

3. The multi-band antenna assembly of claim 1, wherein the second resonant element is disposed substantially perpendicular to the connection conductor.

4. The multi-band antenna assembly of claim 1, wherein the multi-band antenna assembly comprises a first working band of 850-950 MHz and a second working band of 1560-2190 MHz.

5. The multi-band antenna assembly of claim 1, wherein the multi-band antenna assembly comprises a first working band of 840-980 MHz and a second working band of 1700-2560 MHz.

6. The multi-band antenna assembly of claim 1, wherein the distance between the fourth conductor and the first conductor is approximately 1.1 mm.

7. The multi-band antenna assembly of claim 1, wherein the second conductor comprises a gap, to increase the electric length of the second conductor.

8. The multi-band antenna assembly of claim 1, wherein the second resonant element comprises a gap, to increase the electric length of the second resonant element.

9. The multi-band antenna assembly of claim 1, wherein the third conductor is electrically connected with the grounding part.

10. The multi-band antenna assembly of claim 9, wherein the connection conductor, the first resonant element, the second resonant element and the parasitic resonant element are integrated.
